(19) United States
(12) Patent Application Publication
(10) Pub. No.: US 2024/0084202 A1
(43) Pub. Date: Mar. 14, 2024

(54) Emergency Distillation Column and Use Thereof

(71) Applicant: Itelyum Regeneration S.r.l., Pieve Fissiraga (LO) (IT)

(72) Inventors: Francesco Gallo, Pieve Fissiraga (LO) (IT); Oscar Pelis, Pieve Fissiraga (LO) (IT); Alessandro Quaglia, Pieve Fissiraga (LO) (IT); Aldo Roldi, Pieve Fissiraga (LO) (IT)

(21) Appl. No.: 18/514,516

(22) Filed: Nov. 20, 2023

Related U.S. Application Data
(62) Division of application No. 17/367,123, filed on Jul. 2, 2021.

(30) Foreign Application Priority Data
Jul. 3, 2020 (IT) 102020000016126

(51) Int. Cl. C10G 7/00; B01D 3/10; B01D 3/32

(52) U.S. Cl. CPC C10G 7/006; B01D 3/106; B01D 3/32; C10G 2300/1007

(57) ABSTRACT

An emergency distillation column (2) is disclosed, connected to a plant wherein a main distillation column (1) is present. Such connection occurs by means of by-pass of the pipes which supply said main column, which by-pass has stopping means of the liquid which allow the supply of said emergency column when the pressure drops downstream of the main column exceed a preset threshold value. Preferably, said stopping means are shut-off valves (28; 33; 35).

A process of use of a column (2) is furthermore described as in any one of the preceding claims wherein the pressure difference between inflow and outflow of the liquid being distilled is measured continuously and compared against a dedicated threshold.

Finally, a plant for the regeneration of waste oils is disclosed, comprising a distillation column, which furthermore comprises an emergency distillation column (2), as previously defined.

### CROSS REFERENCE TO RELATED APPLICATION

This application is a divisional application that takes priority from and claims the benefit of U.S. patent application Ser. No. 17/367,123 filed on Jul. 2, 2021, which in turn takes priority from and claims the benefit of Italian Patent Application No. 102020000016126 filed on Jul. 3, 2020, the contents of which are in herein incorporated by reference.

### BACKGROUND OF THE INVENTION

### Field of the Invention

The present invention refers to an emergency distillation column and to the use thereof, in particular in a process and in a plant for the regeneration of waste oils.

### Description of the Related Art

Distillation is a process which has been widely known for a very long time also to many lay users, since it seems that it was used in Mesopotamia, already between the VII and the VI century before Christ. It is known that Egyptians used it to obtain flavours and fragrances around 4000 before Christ, while the production of drinks has historical roots dating back to the end of the Middle Ages, at the schools of Salerno, Montpellier and Toledo, where the production of brandy was started, initially for purely digestive purposes.

Distillation, in more scientific terms, is a separation process of two or more substances in a mixture in the liquid state. It consists in supplying heat to the mixture, causing the temperature thereof to rise, up to the boiling point of the liquid which has the lowest boiling point. At that point, the temperature stops rising and remains stationary, boiling begins and the substance with the lowest boiling point evaporates, leaving the mixture. Vapours are removed from the space where they form, channelled and cooled, obtaining the condensation of the liquid, now of high purity.

Once the substance with the lowest boiling point has been completely removed, the temperature of the mixture starts to rise again, until it reaches the boiling point of the second substance with the lowest boiling point, the boiling of said substance begins, the temperature stops again, the vapours of said second substance are collected and condensed and so on, until all the components are removed from the mixture which it was desired to remove.

A typical distillation example is precisely the one for hydro-alcoholic solutions. If wine or beer are poured into a retort, the temperature is first brought to 64.7° C. Methanol boiling is thus achieved. The vapours are cooled and the obtained methanol is discarded. Then, once all the methanol has been removed, the temperature starts rising again and reaches 78.1° C., when boiling of the mixture ethanol 95%-water 5% takes place, which is removed from the original mixture. Ethanol vapours are condensed and the condensate is collected for use. When there is no more ethanol in the mixture, the temperature starts rising again up until 100° C., when water evaporation takes place.

The example just given is a simple distillation example, but it introduces one of the problems of this practice: it is not possible to obtain ethanol devoid of water by simple distillation, since the mixture ethanol-water 95:5 has a lower boiling point than both its components and is defined “azeotropic mixture”. The separation of azeotropic mixtures is one of the problems which can arise in distillation practice and has required to put in place more complex solutions, which allowed to overcome the obstacle.

Although it started from the preparation of spirits and pure alcohol, distillation is widely used also in other sectors, such as in the petrochemical industry, and the oil fractioned distillation process is known, which gives origin to the fractions of fuels and to the raw materials for the organic chemical industry.

Among the products of the petrochemical industry there are also lubricants, such as oils for engines or for machine tools. They too are normally produced starting from oil and distilling it, then the fractions of interest are further processed for imparting to the lubricants the physical and chemical-physical properties necessary for the desired performances.

As is known, lubricants deteriorate with use, since the movements between the parts in which they are involved are nevertheless linked to considerable frictions, even in the presence of lubrication, with heat build up and resulting dehydration, dehydrogenation, cleavage, cracking, condensation, recombination reactions and the like. This situation causes the chemical composition of the lubricants to change over time, also to a remarkable degree. Moreover, solid, metal or polymer particles can collect in the lubricant by detachment due to machine wall scratching. All this causes the deterioration of performances over time and, in the long run, use of the lubricant, by now changed, can even prove damaging for the machines in which it is employed.

It is then necessary, in order to restore good lubrication, to temporarily stop the machines and replace the waste lubricant with fresh lubricant. Waste lubricant is harmful to the environment, consisting of toxic substances and low-degradation substances. For this reason, already for a long time, it has been compulsory to collect waste lubricants and to bring them to compulsory consortia, to avoid improper disposal and the pollution of soil and groundwater.

The disposal of these waste oils, also regularly collected by consortia, is a problem which has been faced over time in ways which are also very different from one another. Firstly, oil was variously burnt, to get rid of it. However, this solution has two drawbacks: it creates greenhouse gases (when it does not produce also toxic gases) and does not allow to enhance the waste. For this reason, solutions were devised which provide to recover the waste oil, eliminating all that reduces the quality thereof and obtaining bases for lubricants, to be then processed in order to obtain again lubricants with the desired performances, and bitumen, which can have different uses, depending on its quality.

Among the processes for the recovery and enhancement of waste oils, a good deal of them—some of which patented by the present Applicant—provide distillation steps, as flash distillation or in packed column, sometimes managed under a reduced pressure or even under vacuum. The problem linked to this packed columns is that, due to the impurities contained in the oil to the regenerated, it can clog, causing remarkable pressure drops and making distillation impossible, at a certain point, finally blocking the liquid in the processing pipes. This forces to stop the plant, clean the distillation packed column, possibly replace the filling and restart the plant; all that implies remarkable problems, reducing plant productivity, diminishing the energy efficiency thereof and damaging the components of the plant in which the process is carried out. Not only that, but, even before coming to a clogging which forces to stop the process, the accumulation of clogging substances starts to oppose the flow of process liquids, remarkably increasing energy consumption with the same yield.

US2012/031 747 discloses a separation method of high-boiling and low-boiling fractions by distillation.

U.S. Pat. No. 5,590,543 discloses a fractioned distillation process of liquid air. An auxiliary column is provided for the absorption of impurities, after the outflow from the distillation column.

### SUMMARY OF THE INVENTION

The problem at the base of the invention is that of proposing a distillation column which overcomes the mentioned drawbacks and which allows to avoid the clogging and the idle time of the plant for the cleaning of the column and the possible replacement of the filling. This object is achieved through an emergency distillation column, connected to a plant wherein a main distillation column is present, characterised in that such connection occurs by means of by-pass of the pipelines which supply said main column, which by-pass has liquid stopping means which allow the supply of said emergency column when the pressure drops downstream of the main column exceed a preset threshold value. The present invention, according to a second aspect, refers to a plant for the regeneration of waste oils, comprising a distillation column (1), characterised in that it furthermore comprises an emergency distillation column (2) as defined above. The dependent claims describe preferential features of the invention.

Further features and advantages of the invention are in any case more apparent from the following detailed description of a preferred embodiment, given purely as a non-limiting example and illustrated in the attached drawing, which represents the part of a plant comprising a distillation column, based on a preferred embodiment of the present invention.

### BRIEF DESCRIPTION OF THE DRAWINGS

FIG. 1 is a schematic diagram of an example distillation column as disclosed herein.

### DETAILED DESCRIPTION OF THE SEVERAL EMBODIMENTS

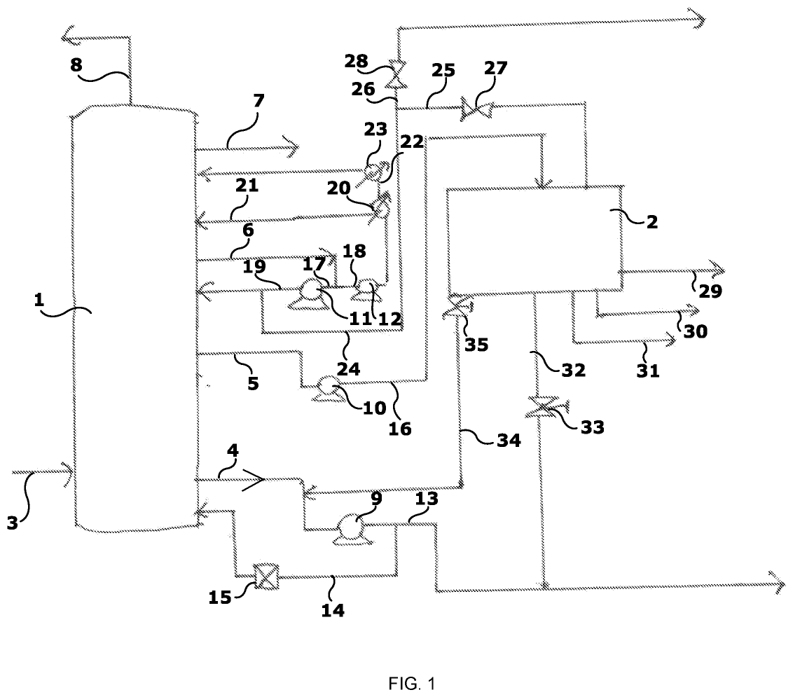

FIG. 1 represents a portion of a generic chemical or petrochemical plant.

Based on such representation, the plant comprises a distillation column 1 and, according to the present invention, an emergency distillation column 2; based on a preferred embodiment, column 2 has a smaller volume than that of main distillation column 1, since the intervention thereof is expected to be temporary.

A mixture to be separated is supplied to column 1 in flow 3. Column 1 can be a column of any type: tray column, flash column, packed column. Preferably, it is a packed column or a tray column, the latter making it easier to measure and assess pressure drops.

Various flows 4, 5, 6, 7 come out from column 1 and, at the head of the column, a discharge of head product 8 comes out.

Flows 4-6 are managed by means of respective pumps or compressors 9-12.

Analysing the individual flows, the paths are as described in the following.

Flow 4 is supplied to a pump or compressor 9. outflow 13 from pump 9 undergoes a by-pass with a flow 14, which provides on its path a shut-off valve 15, which opens to flow 14 a recycling on the bottom of column 1. Flow 13 goes to the further process steps, relating to the product contained in the same flow 13.

Flow 5 is supplied to a pump or to a compressor 10. Flow 16 coming out of pump 10 is supplied to emergency column 2.

Flow 6 is split into two flows, 17 and 18, respectively. Flow 17 is supplied to a pump or compressor 11, which has an outflow 19, which goes back in as recycling into column 1. Flow 18 is supplied to a pump or compressor 12, which supplies it to a heat exchanger 20. From heat exchanger 20 two flows come out. The first flow 21 goes back into column 1 directly, at the temperature obtained due to the heat exchange with heat exchanger 20. The second flow 22 is supplied to a second heat exchanger 23 which brings it to a higher temperature and recycles it to column 1, in a higher position than flow 21. Going back to flow 19, coming out of pump 11, it is split and, in addition to flow 19, recycled, as seen, in column 1, a second flow 24 is obtained. Flow 24 is split into two flows 25 and 26, provided with a shut-off valve 27 and 28, respectively. Flow 26 is recovered as product, while flow 25 is supplied to column 2. Column 2 is preferably of the same type as column 1 (so as not to require a recalibration of the operating parameters) and implies outflows 29, 30 and 31. Another outflow 32 provides a shut-off valve 33 and joins flow 13. Finally, an outflow 34, controlled by a shut-off valve 35, sends a flow coming out from column 2 to join flow 4. From the above, it is easily inferred that said liquid stopping means are shut-off valves 28, 33 and 35.

During standard operation, the oil to be regenerated is supplied in 3 to column 1. The fractioned distillation leads to a series of fractions having different weight and hence with different boiling point, partly directed to the recovery as more or less noble product, partly recycled. Normally, column 1 is capable of distilling, in a known manner, the oil fractions in a standard manner.

According to the present invention, the pressure difference between inflow ad outflow of the liquid being distilled is measured continuously and compared against a dedicated threshold. Preferably, said threshold ranges between 2 and 100 torr (from 266.64 to 13, 332.2 Pa), more preferably between 5 and 50 torr (from 666.61 to 6,666.1 Pa), in the most preferred ways from 7 to 15 torr (from 933.25 to 1,999.83 Pa); thereby, the quality of the products is not worsened, due to the clogging of column 1. The measuring of said pressure difference can be done at different locations, for example at the inflow of column 1 and in correspondence of one of the outflows, or on one of the trays of column 1 or at any other reference location.

As long as the measured pressure difference is below said threshold, column 1 works independently to continue distillation and emergency column 2 remains inactive. When the pressure difference rises above the preset threshold, sign of a progressing clogging, emergency column 2 comes into action, so as to be able to maintain the plant in full operation. Valves 27, 33 and 35 open and column 2 is activated. Flow 16 and flow 25 enter column 2 and the separation by distillation thereof is started. From column 2 flows 29, 30 and 31 come out, which are sent directly to product recovery. Flow 32 joins instead flow 13, while flow 34 joins flow 4, to give flows 13 and 14. Advantageously, emergency column 2 operates at a pressure of 2,000-3,500 Pa.

Column 1 is thus deactivated and it can be provided to the regeneration thereof, in a way known per se, removing all the clogging material, while column 2 continues for this time the desired separation for the process.

Based on a preferred embodiment of the present invention, a liquid loop pump is associated with emergency column 2, apt to keep the vacuum at the head of column 2, without increasing excessively overall energy consumption.

Once regeneration has been carried out, column 1 is restarted and the measuring of the pressure difference will give a value below the threshold one. Thereby, valves 27, 33 and 35 are closed and column 2 stops working, leaving the task to column 1 only.

At this point, it can be suitable to clean column 2, so as to keep it ready for any new interventions, without the risk of finding it too clogged and to have to still stop the plant, impairing the extraordinary effects of the present invention.

Thereby, it is possible to avoid to forcedly stop the plant, thus reducing losses of energy and material, always operating in optimal flow and energy consumption conditions and maintaining unchanged product quality. Column 2, as can be seen, can be sized smaller, since the work is normally carried out for very short periods of time. A good arrangement of the connections between emergency column 2 and the rest of the plant allows to minimise the increase of consumption linked to the operation of column 2, using the ancillary produced energy in the various stages of the process or exploiting for its own functioning apparatuses already in use.

In another alternative embodiment, a thermal deasphaltation column is provided for the regeneration of waste oils, consisting of two separate fractionating segments, one consisting of a main distillation column 1 and the other consisting of an emergency column 2, as seen before. The column is preferably under vacuum. Based on this embodiment, the two segments operate in a complementary way and one supporting the other.

Based on this embodiment, the thermal deasphaltation column thus formed in two segments has a varying number of trays, depending on the quality of the waste oil to be regenerated.

However, it is understood that the invention must not be considered limited to the particular arrangement illustrated above, which makes up only an exemplifying embodiment thereof, but that different variants are possible, all within the reach of a person skilled in the field, without departing from the scope of protection of the invention, as defined by the following claims.

### LIST OF REFERENCE CHARACTERS

1 Primary distillation column
2 Emergency distillation column
3 Supply flow (of 1)
4 Outgoing flow (from 1)
5 Outgoing flow (from 1)
6 Outgoing flow (from 1)
7 Outgoing flow (from 1)
8 Flow produced at the head (from 1)
9 Pump or compressor
10 Pump or compressor
11 Pump or compressor
12 Pump or compressor
13 Outgoing flow (from 9)
14 Flow
15 Shut-off valve (of 14)
16 Outgoing flow (from 10)
17 Flow
18 Flow
19 Outgoing flow (from 11)
20 Heat exchanger
21 Recycling point (in 1)
22 Outgoing flow (from 20)
23 Heat exchanger
24 Flow
25 Flow
26 Flow
27 Shut-off valve (of 25)
28 Shut-off valve (of 26)
29 Outgoing flow (from 2)
30 Outgoing flow (from 2)
31 Outgoing flow (from 2)
32 Flow
33 Shut-off valve (of 32)
34 Outgoing flow (from 2)
35 Shut-off valve (of 34)

What is claimed is:

1. An emergency distillation column (2), connected to a plant wherein a main distillation column (1) is present, characterised in that such connection occurs by means of by-pass of the pipes which supply said main column, which by-pass has liquid stopping means which allow the supply of said emergency column when the pressure drops downstream of the main column exceed a preset threshold value.

2. The emergency distillation column (2) as in claim 1, characterised in that it has a smaller volume than that of the main distillation column (1).

3. The emergency distillation column (2) as in claim 1, characterised in that said liquid stopping means are shut-off valves (28; 33; 35).

4. A thermal deasphaltation column for regenerating waste oils, characterised in that it consists of two separate fractionating segments, one consisting of a main distillation column (1) and the other consisting of a column (2) as in any one of the preceding claims, preferably under vacuum, and in that said two segments operate in a complementary way and one supporting the other.

5. The thermal deasphaltation column as in claim 4, characterised in that the number of trays of said column can vary, depending on the quality of the waste oil to be regenerated.

6. The thermal deasphaltation column as in claim 5 further comprising a number of trays, wherein the number of trays can vary depending on a quality of the waste oil to be regenerated.
